(19) United States
(12) Patent Application Publication
(10) Pub. No.: US 2012/0281441 A1
(43) Pub. Date: Nov. 8, 2012

(54) CIRCUIT FOR CONVERTING A DIRECT CURRENT VOLTAGE TO AN ALTERNATING CURRENT VOLTAGE

(76) Inventors: Yung-Hsiang Liu, Taipei City (TW); Kuo-Hsin Chu, Hsinchu County (TW); Yu-Kai Wang, Kaohsiung City (TW); Yuan-Chao Niu, Taipei City (TW)

(21) Appl. No.: 13/237,980

(22) Filed: Sep. 21, 2011

(30) Foreign Application Priority Data
May 2, 2011 (TW) 100115340

(51) Int. Cl. H02J 3/36

(52) U.S. Cl. 363/35

(57) ABSTRACT

A circuit for converting a direct current voltage into an alternating current voltage includes a buck converter, a resonant DC voltage/DC voltage converter, a DC voltage/AC voltage inverter, and a DC link capacitor. The buck converter generates a DC current according to an input voltage generated by a voltage source operating at an optimal operation point. The resonant DC voltage/DC voltage converter converts the input voltage to a DC voltage according to a switch clock and a resonant frequency determined by a resonant capacitor and a resonant inductance of the resonant DC voltage/DC voltage converter. The DC voltage/AC voltage inverter converts the DC voltage and outputs an AC voltage to an AC power supply network. The DC link capacitor adjusts power outputted by the DC voltage/AC voltage converter to regulate the DC voltage.

### BACKGROUND OF THE INVENTION

1. Field of the Invention

The present invention is related to a circuit for converting a direct current (DC) voltage into an alternating current (AC) voltage, and particularly to a circuit for converting a DC voltage into an AC voltage that not only has simpler design but also lower switching loss and higher conversion efficiency.

2. Description of the Prior Art

Due to technical requirements and different country-specific rules, a voltage source needs a circuit for converting a DC voltage into an AC voltage to transfer energy of the voltage source to an AC power supply network, and to isolate the voltage source from the AC power supply network.

The circuit for converting the DC voltage into the AC voltage utilizes a buck converter to cope with a large range of variation in an output voltage of the voltage source, and for the voltage source to operate at a maximum power point. When the voltage source operates at the maximum power point, the circuit for converting the DC voltage into the AC voltage can attain optimal conversion efficiency.

In addition, when the circuit for converting the DC voltage into the AC voltage utilizes a hard-switching full bridge unit to convert an input voltage generated by the voltage source to a first AC voltage, and a high frequency transformer to adjust the first AC voltage to a second AC voltage, a transformation ratio of the high frequency transformer is chosen for conditions of the voltage source having the lowest voltage and the circuit for converting the DC voltage into the AC voltage having the highest output voltage due to the hard-switching full bridge unit. An AC current flowing through a primary coil of the high frequency transformer is very high. Therefore, power switches of the hard-switching full bridge unit should be designed to tolerate the AC current and the maximum power of the voltage source. However, switching loss of the power switches increases with power of the voltage source. Therefore, when the circuit for converting the DC voltage into the AC voltage utilizes the hard-switching full bridge unit to convert the input voltage generated by the voltage source to the first AC voltage, the circuit for converting the DC voltage into the AC voltage has high switching loss.

### SUMMARY OF THE INVENTION

An embodiment provides a circuit for converting a DC voltage into an AC voltage. The circuit includes a buck converter, a resonant DC voltage/DC voltage converter, a DC voltage/AC voltage inverter, and a DC link capacitor. The buck converter has a first terminal for coupling to a first terminal of a voltage source, a second terminal for coupling to a second terminal of the voltage source, and a third terminal for outputting a DC current, where the buck converter is used for generating the DC current according to an input voltage of the voltage source when the voltage source operates at an optimal operation point. The resonant DC voltage/DC voltage converter includes a resonant capacitor, a full bridge unit, a high frequency transformer, and a rectifier, where the high frequency transformer includes a primary coil and a secondary coil. The resonant capacitor has a first terminal coupled to the third terminal of the buck converter, and a second terminal coupled to the second terminal of the buck converter, where the resonant capacitor is used for generating a first DC voltage according to the DC current. The full bridge unit has a first terminal coupled to the third terminal of the buck converter, a second terminal coupled to the second terminal of the buck converter, a third terminal, and a fourth terminal, where the full bridge unit is used for converting the first DC voltage to a first AC voltage according to a switch clock. The primary coil has a first terminal coupled to the third terminal of the full bridge unit, and a second terminal coupled to the fourth terminal of the full bridge unit. The secondary coil has a first terminal, and a second terminal for sensing variation of the first AC voltage of the primary coil to generate a second AC voltage. The rectifier has a first terminal coupled to the first terminal of the secondary coil, a second terminal coupled to the second terminal of the secondary coil, a third terminal, and a fourth terminal, where the rectifier is used for rectifying the second AC voltage to the DC voltage. The DC voltage/AC voltage inverter has a first terminal coupled to the third terminal of the rectifier for receiving the DC voltage, a second terminal coupled to the fourth terminal of the rectifier, a third terminal for outputting an AC voltage to a first terminal of an AC power supply network, and a fourth terminal for coupling to a second terminal of the AC power supply network. The DC link capacitor has a first terminal coupled to the third terminal of the rectifier, and a second terminal coupled to the fourth terminal of the rectifier, where the DC link capacitor is used for adjusting power outputted by the DC voltage/AC voltage inverter to regulate the DC voltage.

The present invention provides a circuit for converting a DC voltage into an AC voltage. The circuit utilizes a buck converter for a voltage source to operate at an optimal operation point, a high frequency transformer of a resonant DC voltage/DC voltage converter to fix a ratio of a first DC voltage to a DC voltage, and a DC voltage/AC voltage inverter to convert the DC voltage to an AC voltage and to output the AC voltage to an AC power supply network. In addition, a full bridge unit of the resonant DC voltage/DC voltage converter operates in a resonant mode with a resonant frequency, so switching loss of the full bridge unit can be reduced to a minimum value. That is to say, although the full bridge unit operates with the hard-switching mode, the full bridge unit has low switching loss characteristic of the soft-switching mode. In addition, the full bridge unit, the high frequency transformer, and a rectifier of the resonant DC voltage/DC voltage converter can provide a galvanic isolation function for isolating the voltage source from the AC power supply network. Therefore, the present invention not only has simpler design but also lower switching loss and higher conversion efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a circuit for converting a DC voltage into an AC voltage according to an embodiment.

FIG. 2 is a diagram illustrating current flowing through the primary coil and the first DC voltage.

FIG. 3 is a diagram illustrating a circuit for converting a DC voltage into an AC voltage according to another embodiment.

### DETAILED DESCRIPTION

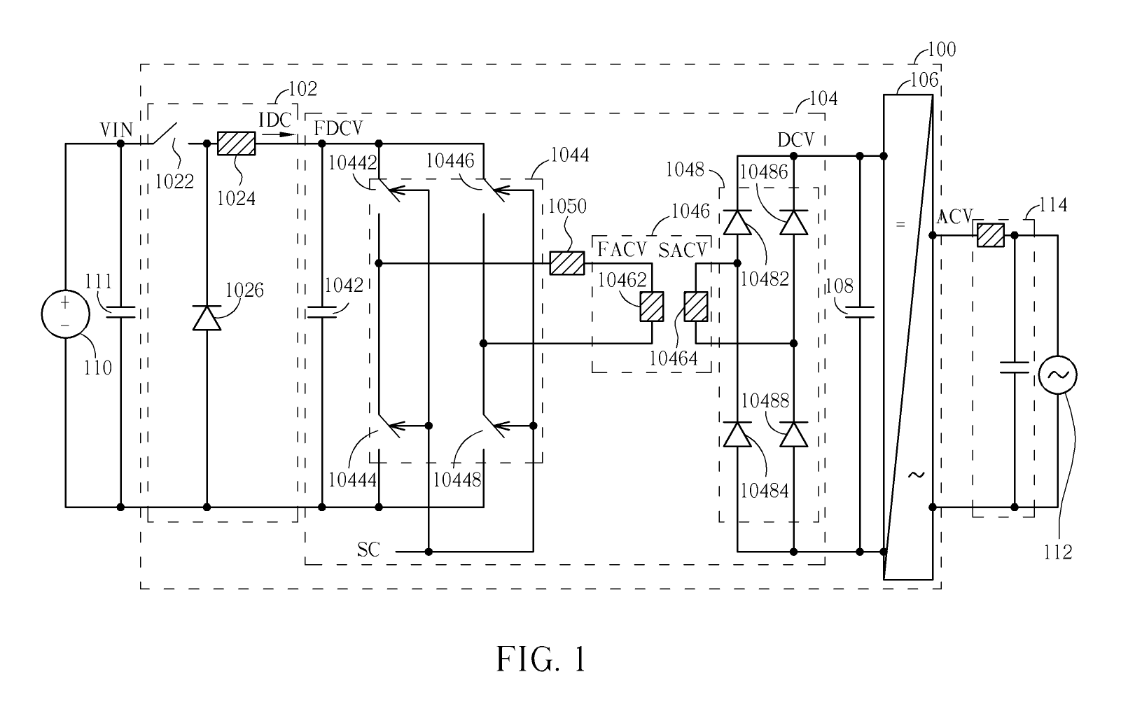

Please refer to FIG. 1. FIG. 1 is a diagram illustrating a circuit 100 for converting a DC voltage into an AC voltage according to an embodiment. As shown in FIG. 1, the circuit 100 includes a buck converter 102, a resonant DC voltage/DC voltage converter 104, a DC voltage/AC voltage inverter 106, and a DC link capacitor 108. The buck converter 102 has a first terminal for coupling to a first terminal of a voltage source 110, a second terminal for coupling to a second terminal of the voltage source 110, and a third terminal for outputting a DC current IDC. A stabilization capacitor 111 is coupled between the first terminal and the second terminal of the voltage source 110 for stabilizing an input voltage VIN of the voltage source 110. The buck converter 102 is used for generating the DC current IDC according to the input voltage VIN of the voltage source 110 when the voltage source 110 operates at an optimal operation point, where the optimal operation point of the voltage source 110 is a maximum power point of the voltage source 110. The resonant DC voltage/DC voltage converter 104 includes a resonant capacitor 1042, a full bridge unit 1044, a high frequency transformer 1046, and a rectifier 1048. The resonant capacitor 1042 has a first terminal coupled to the third terminal of the buck converter 102, and a second terminal coupled to the second terminal of the buck converter 102, where the resonant capacitor 1042 is used for generating a first DC voltage FDCV according to the DC current IDC. The full bridge unit 1044 has a first terminal coupled to the third terminal of the buck converter 102, a second terminal coupled to the second terminal of the buck converter 102, a third terminal, and a fourth terminal, where the full bridge unit 1044 is used for converting the first DC voltage FDCV to a first AC voltage FACV according to a switch clock SC (such as 20 KHz). But, the present invention is not limited to the switch clock SC being 20 KHz. The high frequency transformer 1046 includes a primary coil 10462 and a secondary coil 10464. The primary coil 10462 has a first terminal coupled to the third terminal of the full bridge unit 1044, and a second terminal coupled to the fourth terminal of the full bridge unit 1044. The secondary coil 10464 has a first terminal and a second terminal for sensing variation of the first AC voltage FACV of the primary coil 10462 to generate a second AC voltage SACV. The rectifier 1048 has a first terminal coupled to the first terminal of the secondary coil 10464, a second terminal coupled to the second terminal of the secondary coil 10464, a third terminal, and a fourth terminal, where the rectifier 1048 is used for rectifying the second AC voltage SACV to a DC voltage DCV. The DC voltage/AC voltage inverter 106 has a first terminal coupled to the third terminal of the rectifier 1048 for receiving the DC voltage DCV, a second terminal coupled to the fourth terminal of the rectifier 1048, a third terminal for outputting an AC voltage ACV to a first terminal of an AC power supply network 112, and a fourth terminal for coupling to a second terminal of the AC power supply network 112. The DC voltage/AC voltage inverter 106 is used for converting the DC voltage DCV to the AC voltage ACV, and the DC voltage/AC voltage inverter 106 is a single-phase inverter or a three-phase inverter. In addition, a low pass filter 114 is coupled between the AC power supply network 112 and the DC voltage/AC voltage inverter 106 for filtering high frequency components of the AC voltage ACV. The DC link capacitor 108 has a first terminal coupled to the third terminal of the rectifier 1048, and a second terminal coupled to the fourth terminal of the rectifier 1048, where the DC link capacitor 108 is used for adjusting power outputted by the DC voltage/AC voltage inverter 108 to regulate the DC voltage DCV. In addition, the DC voltage DCV is higher than a predetermined multiple (such as 1.5) of a peak value of an AC voltage of the AC power supply network 112.

As shown in FIG. 1, the buck converter 102 includes a first switch 1022, an inductor 1024, and a diode 1026. The first switch 1022 has a first terminal for coupling to the first terminal of the voltage source 110, and a second terminal. The first switch 1022 adjusts a duty cycle for the voltage source 110 to operate at the optimal operation point, and the first switch 1022 is an insulated gate bipolar transistor, a gate turn-off thyristor, or a metal-oxide-semiconductor field effect transistor. The inductor 1024 has a first terminal coupled to the second terminal of the first switch 1022, and a second terminal coupled to the first terminal of the resonant capacitor 1042. The inductor 1024 is used for generating the DC current IDC according to the input voltage VIN of the voltage source 110. The diode 1026 has a first terminal coupled to the second terminal of the first switch 1022, and a second terminal coupled to the second terminal of the resonant capacitor 1042. The diode 1026 is used for maintaining direction of the DC current IDC when the first switch 1022 is turned off. In addition, the first DC voltage FDCV is less than the input voltage VIN, and the buck converter 102 can be for voltages of various voltage sources. For example, voltages are generated by a photovoltaic generator operating in different light and temperatures, and voltages are generated by various voltage sources.

As shown in FIG. 1, the full bridge unit 1044 includes a second switch 10442, a third switch 10444, a fourth switch 10446, and a fifth switch 10448. The second switch 10442 has a first terminal coupled to the first terminal of the resonant capacitor 1042, and a second terminal coupled to the first terminal of the primary coil 10462. The third switch 10444 has a first terminal coupled to the first terminal of the primary coil 10462, and a second terminal coupled to the second terminal of the resonant capacitor 1042. The fourth switch 10446 has a first terminal coupled to the first terminal of the resonant capacitor 1042, and a second terminal coupled to the second terminal of the primary coil 10462. The fifth switch 10448 has a first terminal coupled to the second terminal of the primary coil 10462, and a second terminal coupled to the second terminal of the resonant capacitor 1042. The second switch 10442 and the fifth switch 10448 are turned on during a first half period of the switch clock SC and are turned off during a second half period of the switch clock SC. The third switch 10444 and the fourth switch 10446 are turned on during the second half period of the switch clock SC and are turned off during the first half period of the switch clock SC. A dead time exists between the first half period and the second half period of the switch clock SC for preventing the second switch 10442, the fifth switch 10448, and the third switch 10444, the fourth switch 10446 from turning on simultaneously. In addition, the second switch 10442, the third switch 10444, the fourth switch 10446, and the fifth switch 10448 are insulated gate bipolar transistors, gate turn-off thyristors, or metal-oxide-semiconductor field effect transistors.

As shown in FIG. 1, the rectifier 1048 includes a first diode 10482, a second diode 10484, a third diode 10486, and a fourth diode 10488. The first diode 10482 has a first terminal coupled to the first terminal of the DC voltage/AC voltage inverter 106, and a second terminal coupled to the first terminal of the secondary coil 10464. The second diode 10484 has a first terminal coupled to the first terminal of the secondary coil 10464, and a second terminal coupled to the second terminal of the DC voltage/AC voltage inverter 106. The third diode 10486 has a first terminal coupled to the first terminal of the DC voltage/AC voltage inverter 106, and a second terminal coupled to the second terminal of the secondary coil 10464. The fourth diode 10488 has a first terminal coupled to the second terminal of the secondary coil 10464, and a second terminal coupled to the second terminal of the DC voltage/AC voltage inverter 106. During the first half period of the switch clock SC, the first diode 10482 and the fourth diode 10488 conduct, and the second diode 10484 and the third diode 10486 conduct during the second half period of the switch clock SC.

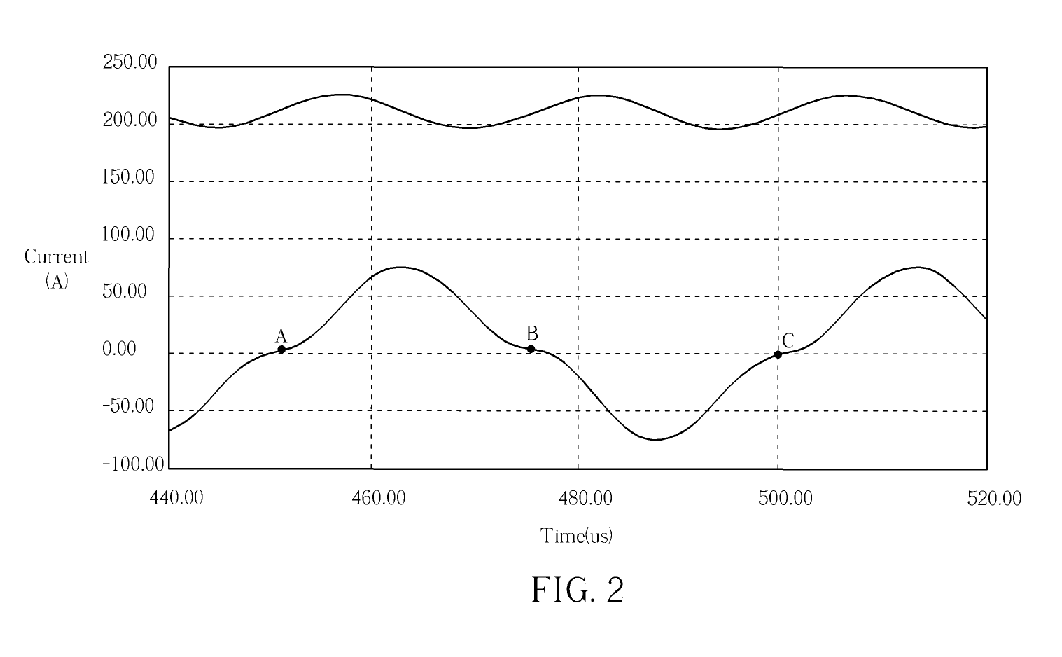

Please refer to FIG. 2. FIG. 2 is a diagram illustrating current flowing through the primary coil 10462 and the first DC voltage FDCV. As shown in FIG. 1, a resonant inductor 1050 is coupled between the full bridge unit 1044 and the primary coil 10462 for determining a resonant frequency with the resonant capacitor 1042. Frequency of the switch clock SC is lower than the resonant frequency, and the resonant frequency is much higher than a frequency of the AC power supply network 112. The full bridge unit 1044, the high frequency transformer 1046, and the rectifier 1048 provide the circuit 100 with a galvanic isolation function for isolating the voltage source 110 from the AC power supply network 112. The full bridge unit 1044 converts the first DC voltage FDCV to the first AC voltage FACV. Then, the high frequency transformer 1046 converts the first AC voltage FACV to the second AC voltage SACV at a predetermined voltage level. When the second switch 10442, the third switch 10444, the fourth switch 10446, and the fifth switch 10448 operate in a resonant mode with the resonant frequency, switching loss of the second switch 10442, the third switch 10444, the fourth switch 10446, and the fifth switch 10448 can be reduced to a minimum value. That is to say, although operation of the second switch 10442, the third switch 10444, the fourth switch 10446, and the fifth switch 10448 operates with a hard-switching mode, the full bridge unit 1044 still has a low switching loss characteristic of a soft-switching mode. Because the full bridge unit 1044 operates in the hard-switching mode, a shape of the first AC voltage FACV should be a square wave, and variation range of the current flowing through the primary coil 10462 is between 0 amperes to tens of amperes. However, when the full bridge unit 1044 works with the resonant inductor 1050 and the resonant capacitor 1042, the full bridge unit 1044 converts a shape of the current flowing through the primary coil 10462 to a sinusoidal wave through the resonant inductor 1050 and the resonant capacitor 1042, so switching loss of the current flowing through the primary coil 10462 can be decreased. For example, in FIG. 2, the second switch 10442, the third switch 10444, the fourth switch 10446, and the fifth switch 10448 are switched at switching points A, B, C, but the full bridge unit 1044 can approach having the current flowing through the primary coil 10462 at near zero current switching at the switching points A, B, C through the resonant inductor 1050 and the resonant capacitor 1042. Therefore, as shown in FIG. 2, a current resonant frequency between the switching points A, B is two times the switch clock SC, and the resonant frequency of the first DC voltage FDCV is the same as the current resonant frequency. Thus, conversion efficiency of the circuit 100 is increased. In addition, when the second switch 10442, the third switch 10444, the fourth switch 10446, and the fifth switch 10448 operate in the resonant mode with the resonant frequency, a ratio of the first DC voltage FDCV to the DC voltage DCV is determined by a ratio of the primary coil 10462 to the secondary coil 10464. In addition, in another embodiment, the resonant DC voltage/DC voltage converter 104 does not include the resonant inductor 1050, and the resonant capacitor 1042 determines the resonant frequency with a leakage inductor of the primary coil 10462.

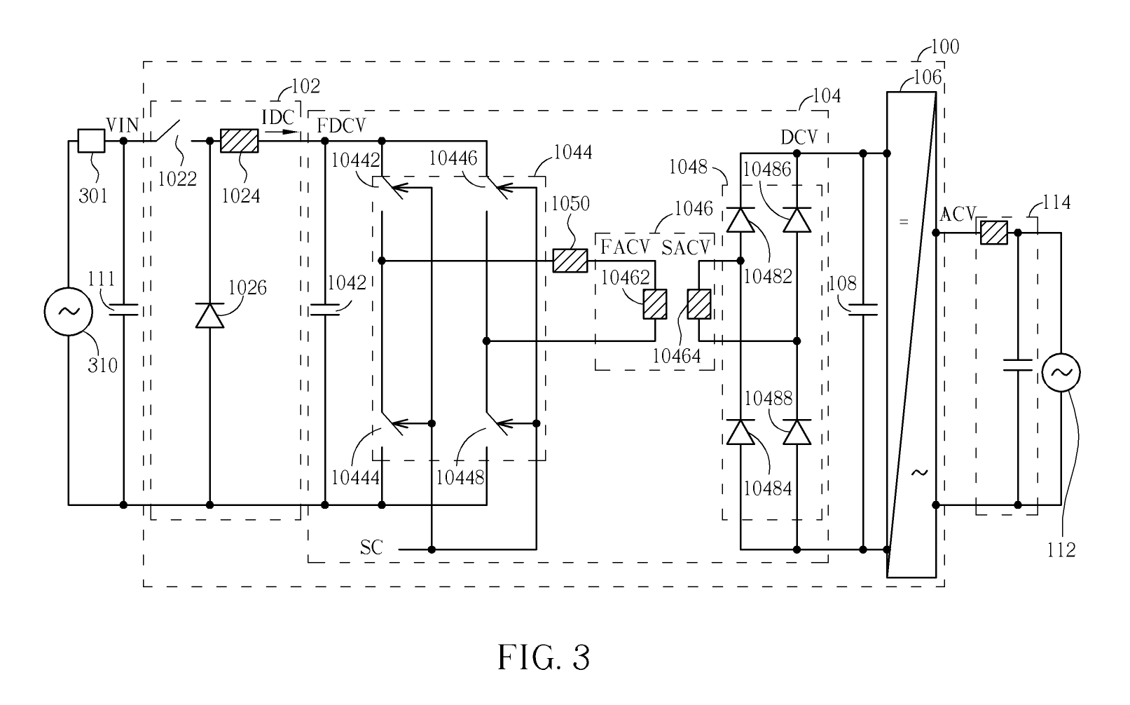

In addition, as shown in FIG. 1, the voltage source 110 is a photovoltaic generator, a fuel cell, or a battery. Please refer to FIG. 3. FIG. 3 is a diagram illustrating a circuit 100 for converting a DC voltage into an AC voltage according to another embodiment. As shown in FIG. 3, the voltage source 310 is a wind power plant with a permanent-magnet (PM) generator, a combustion engine with a PM generator, or a water power plant with a PM generator. Because the voltage source 310 is used for generating a third AC voltage TACV, a pre-rectifier 301 is coupled between the buck converter 102 and the voltage source 310 for rectifying the third AC voltage TACV generated by the voltage source 310 to the input voltage VIN. Further, subsequent operational principles of the embodiment in FIG. 3 are the same as those of the embodiment in FIG. 1, so further description thereof is omitted for simplicity.

To sum up, the circuit for converting the DC voltage into the AC voltage utilizes the buck converter for the voltage source to operate at the optimal operation point, the high frequency transformer of the resonant DC voltage/DC voltage converter to fix the ratio of the first DC voltage to the DC voltage, and the DC voltage/AC voltage inverter to convert the DC voltage to the AC voltage and to output the AC voltage to the AC power supply network. In addition, the full bridge unit of the resonant DC voltage/DC voltage converter operates in the resonant mode with the resonant frequency, so the switching loss of the full bridge unit can be reduced to the minimum value. That is to say, although the full bridge unit operates with the hard-switching mode, the full bridge unit still has the low switching loss characteristic of the soft-switching mode. In addition, the full bridge unit, the high frequency transformer, and the rectifier of the resonant DC voltage/DC voltage converter can provide the galvanic isolation function for isolating the voltage source from the AC power supply network. Therefore, the present invention not only has simpler design but also lower switching loss and higher conversion efficiency.

Those skilled in the art will readily observe that numerous modifications and alterations of the device and method may be made while retaining the teachings of the invention.

What is claimed is:

1. A circuit for converting a direct current (DC) voltage into an alternating current (AC) voltage, the circuit comprising:
a buck converter having a first terminal for coupling to a first terminal of a voltage source, a second terminal for coupling to a second terminal of the voltage source, and a third terminal for outputting a DC current, wherein the buck converter is used for generating the DC current according to an input voltage of the voltage source when the voltage source operates at an optimal operation point;
a resonant DC voltage/DC voltage converter comprising:
a resonant capacitor having a first terminal coupled to the third terminal of the buck converter, and a second terminal coupled to the second terminal of the buck converter, wherein the resonant capacitor is used for generating a first DC voltage according to the DC current;
a full bridge unit having a first terminal coupled to the third terminal of the buck converter, a second terminal coupled to the second terminal of the buck converter, a third terminal, and a fourth terminal, wherein the full bridge unit is used for converting the first DC voltage to a first AC voltage according to a switch clock;
a high frequency transformer comprising:
a primary coil having a first terminal coupled to the third terminal of the full bridge unit, and a second terminal coupled to the fourth terminal of the full bridge unit; and
a secondary coil having a first terminal, and a second terminal for sensing variation of the first AC voltage of the primary coil to generate a second AC voltage; and
a rectifier having a first terminal coupled to the first terminal of the secondary coil, a second terminal coupled to the second terminal of the secondary coil, a third terminal, and a fourth terminal, wherein the rectifier is used for rectifying the second AC voltage to the DC voltage;
a DC voltage/AC voltage inverter having a first terminal coupled to the third terminal of the rectifier for receiving the DC voltage, a second terminal coupled to the fourth terminal of the rectifier, a third terminal for outputting an AC voltage to a first terminal of an AC power supply network, and a fourth terminal for coupling to a second terminal of the AC power supply network; and
a DC link capacitor having a first terminal coupled to the third terminal of the rectifier, and a second terminal coupled to the fourth terminal of the rectifier, wherein the DC link capacitor is used for adjusting power outputted by the DC voltage/AC voltage inverter to regulate the DC voltage.

2. The circuit of claim 1, wherein the buck converter comprises:
a first switch having a first terminal for coupling to the first terminal of the voltage source, and a second terminal, wherein the first switch adjusts a duty cycle for the voltage source to operate at the optimal operation point;
an inductor having a first terminal coupled to the second terminal of the first switch, and a second terminal coupled to the first terminal of the resonant capacitor, wherein the inductor is used for generating the DC current according to the input voltage of the voltage source; and
a diode having a first terminal coupled to the second terminal of the first switch, and a second terminal coupled to the second terminal of the resonant capacitor, wherein the diode is used for maintaining direction of the DC current when the first switch is turned off.

3. The circuit of claim 2, wherein the first switch is an insulated gate bipolar transistor (IGBT), a gate turn-off thyristor (GTO), or a metal-oxide-semiconductor field effect transistor (MOSFET).

4. The circuit of claim 1, wherein the optimal operation point is a maximum power point of the voltage source.

5. The circuit of claim 1, wherein the resonant DC voltage/DC voltage converter further comprises:
a resonant inductor coupled between the full bridge unit and the primary coil for determining a resonant frequency with the resonant capacitor.

6. The circuit of claim 1, wherein the full bridge unit comprises:
a second switch having a first terminal coupled to the first terminal of the resonant capacitor, and a second terminal coupled to the first terminal of the primary coil;
a third switch having a first terminal coupled to the first terminal of the primary coil, and a second terminal coupled to the second terminal of the resonant capacitor;
a fourth switch having a first terminal coupled to the first terminal of the resonant capacitor, and a second terminal coupled to the second terminal of the primary coil; and
a fifth switch having a first terminal coupled to the second terminal of the primary coil, and a second terminal coupled to the second terminal of the resonant capacitor;
wherein the second switch and the fifth switch are turned on during a first half period of the switch clock, and are turned off during a second half period of the switch clock, and the third switch and the fourth switch are turned on during the second half period of the switch clock, and are turned off during the first half period of the switch clock.

7. The circuit of claim 6, wherein a dead time exists between the first half period and the second half period of the switch clock for preventing the second switch, the fifth switch, and the third switch, the fourth switch from turning on simultaneously.

8. The circuit of claim 6, wherein the second switch, the third switch, the fourth switch, and the fifth switch are insulated gate bipolar transistors, gate turn-off thyristors, or
metal-oxide-semiconductor field effect transistors.

9. The circuit of claim 1, wherein the rectifier comprises:
a first diode having a first terminal coupled to the first terminal of the DC voltage/AC voltage inverter, and a second terminal coupled to the first terminal of the secondary coil;
a second diode having a first terminal coupled to the first terminal of the secondary coil, and a second terminal coupled to the second terminal of the DC voltage/AC voltage inverter;
a third diode having a first terminal coupled to the first terminal of the DC voltage/AC voltage inverter, and a second terminal coupled to the second terminal of the secondary coil; and
a fourth diode having a first terminal coupled to the second terminal of the secondary coil, and a second terminal coupled to the second terminal of the DC voltage/AC voltage inverter;
wherein the first diode and the fourth diode conduct during the first half period of the switch clock, and the second diode and the third diode conduct during the second half period of the switch clock.

10. The circuit of claim 1, wherein the DC voltage/AC voltage inverter is a single-phase inverter.

11. The circuit of claim 1, wherein the DC voltage/AC voltage inverter is a three-phase inverter.

12. The circuit of claim 1, wherein the switch clock is lower than the resonant frequency, and the resonant frequency is much higher than a frequency of the AC power supply network.

13. The circuit of claim 1, wherein the voltage source is a photovoltaic generator, a full cell, or a battery.

14. The circuit of claim 1, further comprising:
a pre-rectifier coupled between the buck converter and the voltage source for rectifying an AC voltage generated by the voltage source to the input voltage.

15. The circuit of claim 14, wherein the voltage source is a wind power plant with a permanent-magnet (PM) generator, a combustion engine with a PM generator, or a water power plant with a PM generator.
